(19) United States
(12) Patent Application Publication
(10) Pub. No.: US 2024/0196171 A1
(43) Pub. Date: Jun. 13, 2024

(54) SYSTEM AND METHOD FOR RENDERING MULTICAST BROADCAST SERVICES BASED ON MODULATION

(71) Applicant: Verizon Patent and Licensing Inc., Basking Ridge, NJ (US)

(72) Inventors: David Taft, Keller, TX (US); Anthony Clay Reynolds, Rhome, TX (US); Lap Tse, Marietta, GA (US); Maqbool Chauhan, Keller, TX (US); Sudhakar Reddy Patil, Flower Mound, TX (US); Vijayakrishna P. Guduru, Denville, NJ (US); Vishwanath Ramamurthi, San Ramon, CA (US)

(21) Appl. No.: 18/065,240

(22) Filed: Dec. 13, 2022

(51) Int. Cl. H04W 4/06; H04L 1/00

(52) U.S. Cl. CPC H04W 4/06; H04L 1/0003

(57) ABSTRACT

A system comprises one or more devices. The devices may be configured to: receive information pertaining to a multicast broadcast service (MBS) session; identify, based on the information, User Equipment devices (UEs) that have joined the MBS session; identify at least two modulation schemes that are to be used by the UEs during the MBS session; receive multicast data from a network component; transmit, during the MBS session, the received multicast data to the UEs using the identified at least two modulation schemes.

### BACKGROUND INFORMATION

Multicast Broadcast Services (MBS) include standards for point-to-multipoint communications. When a packet is multicast, the packet is sent from a single source (e.g., a network device with an Internet Protocol (IP) address) to multiple destinations (e.g., multiple devices with IP addresses). In a cellular network that supports MBS, multicast data may be broadcast from a Radio Frequency (RF) base station to User Equipment devices (UEs) over radio links.

### BRIEF DESCRIPTION OF THE DRAWINGS

FIG. 1A illustrates an exemplary Multicast Broadcast Services (MBS) communication;

FIGS. 1B and 1C illustrate concepts described herein;

FIG. 2 illustrates an exemplary network in which a system for rendering MBS based on a modulation may be implemented, according to an implementation;

FIG. 3 depicts exemplary components of a core network, according to an implementation;

FIG. 4 illustrates an exemplary components of an MBS system, according to an implementation;

FIG. 5 shows exemplary components of a system for rendering MBS based on modulation, according to an embodiment;

FIG. 6 shows exemplary components of a queue processor, according to an embodiment;

FIG. 7 depicts exemplary components of a system for rendering MBS based on modulation, according to another embodiment;

FIG. 8 depicts an exemplary components of another queue processor, according to an embodiment;

FIG. 9 is a flow diagram of an exemplary process that is associated with rendering MBS based on modulation, according to an implementation; and

FIG. 10 shows exemplary components of a network device, according to an implementation.

### DETAILED DESCRIPTION

The following detailed description refers to the accompanying drawings. The same reference numbers in different drawings may identify the same or similar elements. As used herein, the term “packet” may refer to an Internet Protocol (IP) packet, a Protocol Data Unit (PDU), or another data unit (e.g., an Ethernet frame).

Systems and methods described herein generally relate to Multicast Broadcast Services (MBS) and more particularly to rendering MBS based on Quadrature Amplitude Modulation (QAM) or Modulation and Coding Scheme (MCS). As used herein, the term QAM refers to a digital modulation and demodulation scheme or method used for signal transmission and reception. QAM uses two carrier waves out-of-phase 90 degrees with varying amplitudes and phases to represent a set of symbols. For example, in 16 QAM, the carrier waves can convey a sequence of 4-bit symbols, where each symbol is presented as a combination of an amplitude value (one of 4 possible amplitudes) and a phase value (one of 4 possible phases). Similarly, 64 QAM can convey a sequence of 8-bit symbols, where each symbol is represented as a combination of one of 8 possible amplitude values and one of 8 possible phase values. Similarly for 4 QAM, 256 QAM, 1024 QAM, etc.

As used herein, the term Modulation and Coding Scheme (MCS), MCS number, or MCS index refers to a number that indicates a combination of two parameters: a code rate (e.g., a ratio of a number of useful bits transmitted to the total number of bits transmitted) and a modulation scheme (e.g., 16 QAM, 64 QAM, etc.). For example, MCS index (or simply MCS) of 3 may indicate a code rate of 0.5 and a 16 QAM. In another example, MCS of 7 may indicate a code rate of 5/6 and 64 QAM.

In the following, the term “modulation” may refer to either a particular QAM or an MCS. In addition, in the following, where the term 4 QAM, 16 QAM, 64 QAM, 256 QAM, etc. appears, the term may be replaced by one of MCSs that uses the particular QAM scheme. When a particular embodiment is described below as including one or more components which depend on or use a particular QAM or modulation, it is assumed that the description also applies to embodiments that include components which depend on or use the corresponding MCS, even if the term MCS is not mentioned or used. For example, descriptions that apply to implementations that use or depend on 16 QAM also apply to implementations that use or depend on MCSs that use 16 QAM,

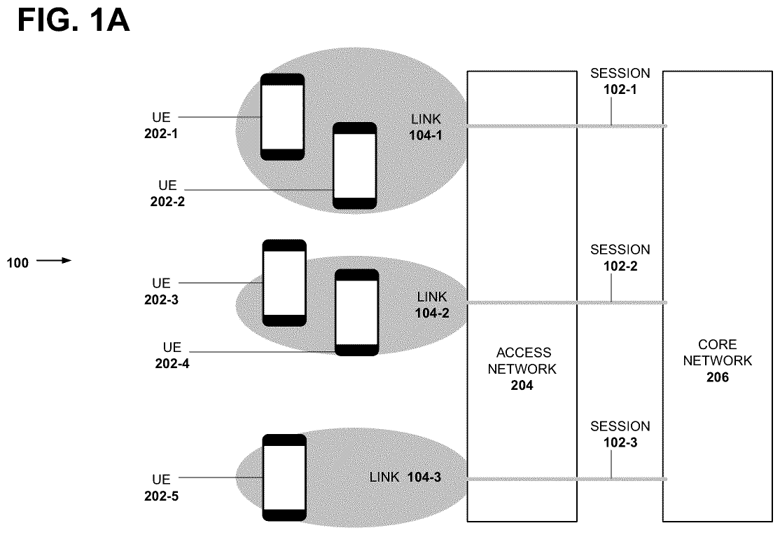

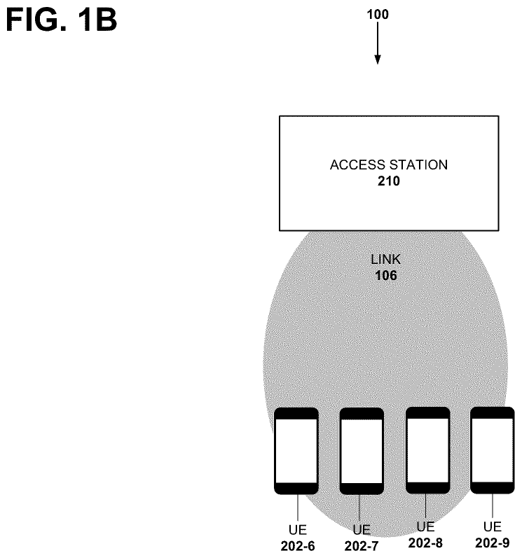

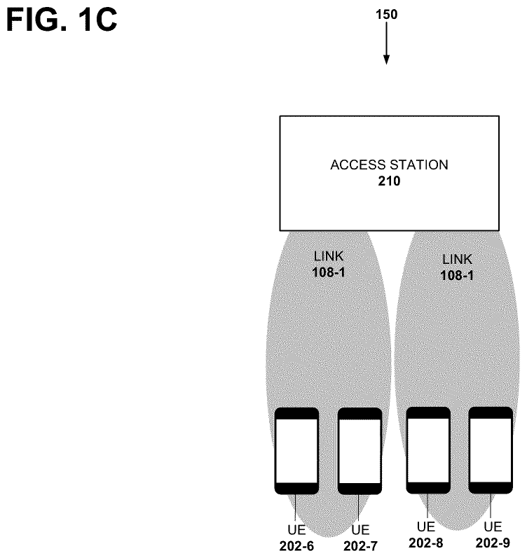

FIGS. 1A-1C provide an overview of the systems and methods described herein. More particularly, FIG. 1A illustrates MBS communication. As shown, core network 206 establishes an MBS session 102-1 with User Equipment devices (UEs) 202-1 and 202-2 (e.g., smart phones). Session 102-1 is established, in part, over a broadcast signal 104-1 (e.g., a radio signal) or a quasi-broadcast signal (an RF signal that reaches more than one UE 202) that extends from an access network 204 to UEs 202-1 and 202-2. FIG. 1A also shows a multicast session 102-2. In contrast to MBS session 102-1, multicast session 102-2 is established, in part, over non-broadcast signal 104-2 between access network 204 and UEs 202-3 and 202-4. MBS session 102-1 is also different from session 102-3, which is established partly over link 104-3 between access network 204 and UE 202-5. In FIG. 1A, only MBS session 102-1 is established over a broadcast signal. As used herein, the term “broadcast signal” may refer to a point-to-multipoint radio signal.

FIGS. 1B and 1C illustrate concepts associated with rendering MBS based on modulation or MCS. As shown in FIG. 1B, access network 204 establishes an MBS session with UEs 202-6 through 202-9 over communication link 106. Because the MBS session involves multiple UEs 202-6 through 202-9, any communication issue (e.g., low Signal-to-Interference and Noise ratio (SINR)) can cause disruptions in link 106 and thus the entire MBS session.

To decrease the session sensitivity to disruptions due to individual UE communication issues, access network 204 may be implemented to render MBS based on modulation or MCS—that is, have access network 204 include a modulation or MCS-based MBS system. As shown in FIG. 1C, to establish an MBS session, access network 204 uses two separate radio links 108-1 and 108-2, where link 108-1 uses a quadrature amplitude modulation (QAM) or MCS different from a QAM or MCS used for link 108-2. For example, link 108-1 may use 64 QAM (or a corresponding MCS) and link 108-2 may use-256 QAM (or a corresponding MCS). Link 108-1 extends from access network 204 to UEs 202-6 and 202-7; and link 108-2 extends from access network 204 to UEs 202-8 and 202-9. In FIG. 1C, assuming that there is no crosstalk between links 108-1 and 108-2, if there is a disruption to the MBS session due to an issue that affects link 108-1 (e.g., low SINR at UE 202-6 or 202-7), the MBS session would not be affected in its entirety—UEs 202-8 and 202-9 may continue to receive data from access network 204 over link 108-2. Thus, in FIG. 1C, the MBS system permits multicast data to be conveyed from a point in access network 204 to UEs 202 over multiple signals with different QAMs, reducing the sensitivity of the MBS session to various UE-related disruptions in MBS communication between the UEs 202 and access network 204.

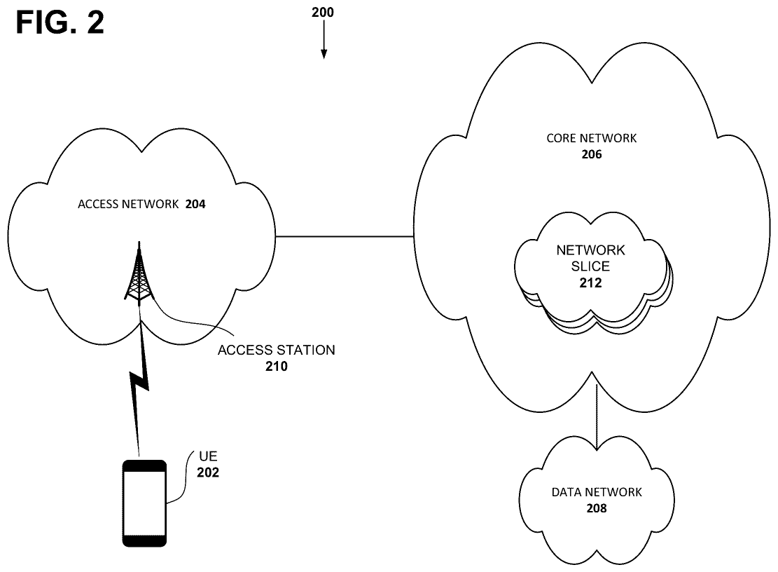

FIG. 2 illustrates network 200 in which a modulation—or MCS—based MBS system may be implemented, according to an embodiment. As shown, network 200 may include a UE 202, an access network 204, a core network 206, and a data network 208. UE 202 may include a wireless communication device. Examples of UE 202 include: a smart phone; a tablet device; a wearable computer device (e.g., a smart watch); a global positioning system (GPS) device; a laptop computer; a fixed wireless (FWA) device; a mobile hot spot (MHS) device; a media playing device; a portable gaming system; an autonomous vehicle navigation system; an automated mobile robot (AMR) device; a sensor, such as a pressure sensor; and an Internet-of-Things (IOT) device. In some implementations, UE 202 may correspond to a wireless Machine-Type-Communication (MTC) device that communicates with other devices over a machine-to-machine (M2M) interface, such as LTE-M or Category M1 (CAT-M1) devices, Red Cap devices, and Narrow Band (NB)-IoT devices.

UE 202 may receive multicast data using point-to-point (PTP) or point-to-multipoint (PTM); handle incoming MBS Quality of Service (QOS) flows; support signaling for joining and leaving MBS sessions; provide MBS resource management support at application layer; and receive notification of in an idle state or a connected state with Radio Resource Control (RRC) inactive state for multicast data transmission.

UE 202 may be capable of using different modulation schemes or MCSs in establishing an MBS session with access network 204. For example, UE 202 may establish a link with one of: a 16-QAM (16 QAM), 64-QAM (64 QAM), 256-QAM (256 QAM), or 1024-QAM (1024 QAM). UE 202 may be capable of negotiating with access network 204 to change its modulation scheme or MCS, change its identifiers that are associated with an MBS session and/or provide device-related parameters to the MBS system (not shown in FIG. 2) in access network 204. For example, UE 202 may forward information that describes its QAM/MCS capabilities (e.g., whether it is capable of 16 QAM, MCS 7, etc.) and/or its other device-related parameters to access network 204.

Access network 204 may allow UE 202 to access core network 206. To do so, access network 204 may establish and maintain, with participation from UE 202, an over-the-air channel with UE 202; and maintain backhaul channels with core network 206. Access network 204 may relay information through these channels, from UE 202 to core network 206 and vice versa. Access network 204 may include a Long-term Evolution (LTE) radio network and/or a Fifth Generation (5G) radio network or other advanced radio network. These networks may include many central units (CUs), distributed units (DUs), radio units (RUs), and wireless stations, one of which is illustrated in FIG. 2 as access station 210 for establishing and maintaining over-the-air channel with UE 202. Access station 210 may include a 4G, 5G, or another type of base station (e.g., eNB, gNB, etc.) that comprise one or more radio frequency (RF) transceivers. In some implementations, access station 210 may be part of an evolved Universal Mobile Telecommunications Service (UMTS) Terrestrial Network (eUTRAN).

To support MBS, access network 204 may perform the following functions: manage MBS QOS flows via N2 interface or N2 reference point; deliver MBS data packets, from core network 206, shared for multiple UEs 292 over radio using PTP or PTM; configure UE 202 for MBS QOS flow reception at the application layer; control switching between PTM and PTP delivery per UE 202; provide support for multicast sessions continuity during handovers; and provide support for notification of multicast session activation over radio toward UEs 202 in an idle and connected state with the RRC inactive state for the MBS session.

In addition, access network 204 may provide modulation—pr<CS-dependent MBS to UE 202. When rendering modulation—or MCS dependent MBS, access network 204 may negotiate, with UE 202, the modulation scheme or MCS, assign MBS-related IDs to UE 202, or modify MBS-related IDs for UE 202. If access network 204 supports use of Multiple-Input Multiple-Output (MIMO) antennas, access network 204 may also assign a beam index (i.e., assign a particular MIMO antenna beam) to further reduce sensitivity of MBS sessions to signal disruptions due to UEs 202.

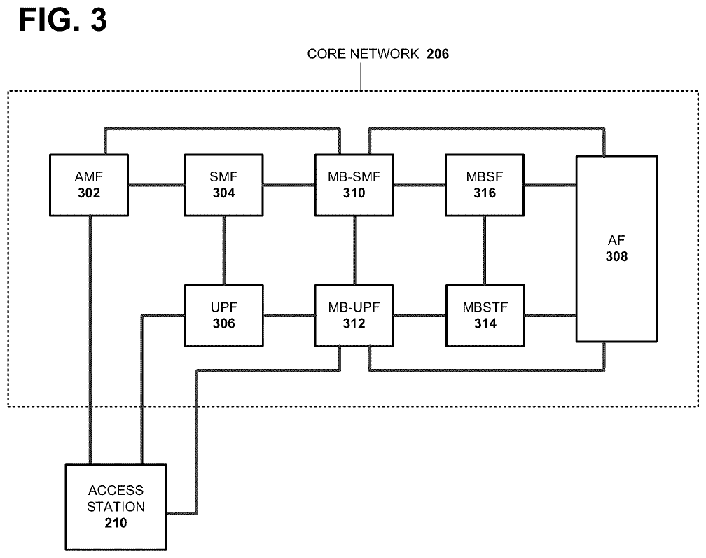

Core network 206 may manage communication sessions of subscribers connecting to core network 206 via access network 204. For example, core network 206 may establish an Internet Protocol (IP) connection between UEs 202 and data network 208. In some implementations, core network 206 may include a 5G core network. In other implementations, core network 206 may include a 4G core network (e.g., an evolved packet core (EPC) network) or another type of core network. Depending on the implementation, core network 206 may include components and/or functions that support MBS. Some of these components are described below with reference to FIG. 3.

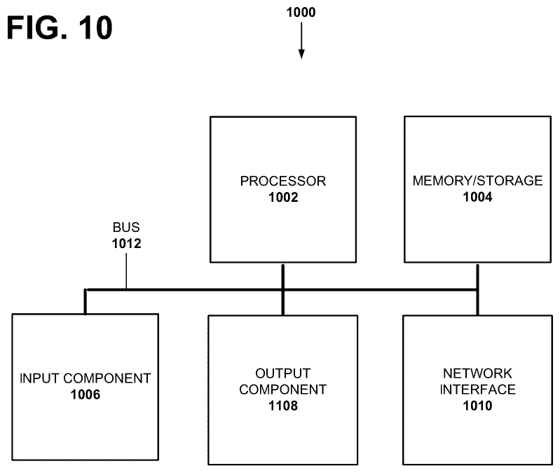

The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a Virtual Network Function (VNF) virtual machine, a container, an event driven server-less architecture interface, and/or another type of SDN component. The common shared physical infrastructure may be implemented using one or more devices 1000 described below with reference to FIG. 10 in a cloud computing center associated with core network 206.

As further shown, core network 206 may include one or more network slices 212. Depending on the implementation, network slices 212 may be implemented within other networks, such as access network 204 and/or data network 208. Access network 204, core network 206, and data network 208 may include multiple instances of network slices 212. Each network slice 212 may be instantiated as a result of “network slicing,” which involves a form of virtual network architecture that enables multiple logical networks to be implemented on top of a shared physical network infrastructure using the SDN and/or network function virtualization (NFV). Each logical network, referred to as a “network slice,” may encompass an end-to-end virtual network with dedicated storage and/or computational resources that include access network components, clouds, transport components, Central Processing Unit (CPU) cycles, memory, etc. Furthermore, each network slice 212 may be configured to meet a different set of requirements and may be associated with a particular Quality of Service (QOS) class, a type of service, 5QI, and/or a particular group of enterprise customers associated with communication devices.

Data network 208 may include one or more networks connected to core network 206. In some implementations, a particular data network 208 may be associated with a data network name (DNN) in 5G, and/or an Access Point Name (APN) in 4G, and a UE 202 may request a connection to data network 208 using a DNN or APN. Data network 208 may include, and/or be connected to and enable communication with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also simply referred to as application). An application may provide services for a program or an application running on UE 202 and may establish communication sessions with UE 202 via core network 206.

Depending on the implementation, network 200 may include additional networks and components than those illustrated in FIG. 2. For clarity, however, FIG. 2 does not show all components that may be included in environment 200 (e.g., routers, bridges, wireless access point, additional UEs 202, switches, etc.).

FIG. 3 depicts exemplary components of core network 206. In the embodiment shown, core network 206 includes one or more 5G components that support MBS, as well as other network functions common to 5G core networks (referred to herein as 5GCs). As shown, core network 206 may include an Access and Mobility Management Function (AMF) 302, a Session Management Function (SMF) 304, a user Plane Function (UPF) 306, an Application Function (AF) 308, a Multicast Broadcast (MB)-SMF 310, an MB-UPF 312, a Multicast Broadcast Transport Function (MBSTF) 314, and a Multicast Broadcast Service Function (MBSF) 316. Each of components 302-316 may include network device 1000 or be implemented on one or more network devices 1000. Depending on the implementation, core network 206 may include additional, fewer, and/or different 5G core network components than those illustrated in FIG. 3.

AMF 302 may perform registration management, connection management, reachability management, mobility management, lawful intercepts, Short Message Service (SMS) transport between UE 202 and a Short Message Service Function (SMSF), session management messages transport between UE 202 and SMF 404, access authentication and authorization, location services management, functionality to support non-Third Generation Partnership Program (3GPP) access networks, and/or other types of management processes.

In addition, AMF 302 may perform the following to support MBS: signaling with access network 204 and MB-SMF 310 for MBS session management; selecting access network 204 for notification of multicast session activation toward UEs 202 in an idle state; and selection of access networks 204 for broadcast traffic distribution.

SMF 304 may perform session establishment, session modification, and/or session release, perform Internet Protocol (IP) address allocation and management, perform Dynamic Host Configuration Protocol (DHCP) functions, perform selection and control of UPF 306, configure traffic steering at UPF 306 to guide the traffic to the correct destinations, terminate interfaces toward a Policy Control Function (PCF), perform lawful intercepts, charge data collection, support charging interfaces, control and coordinate of charging data collection, terminate session management parts of Non-Access Stratum (NAS) messages, perform downlink data notification, manage roaming functionality, and/or perform other types of control plane processes for managing user plane data.

In addition, SMF 304 may perform the following functions to support MBS: discovering MB-SMF 310 for a multicast session; authorizing multicast session join operation for served UEs 202 when needed; interacting with MB-SMF 310 to obtain multicast session context information used as input to modify the Protocol Data Unit (PDU) Session associated with the MBS session; interacting with access network 204 to provide information about a multicast session in which UE 202 participates; and interacting with access network 204 and UPF 306 for multicast data transport using a 5GC Individual MBS traffic delivery method.

UPF 306 may maintain an anchor point for intra/inter-Radio Access Technology (RAT) mobility, maintain an external PDU point of interconnect to a particular data network (e.g., data network 208), perform packet routing and forwarding, perform the user plane part of policy rule enforcement, perform packet inspection, perform lawful intercept, perform traffic usage reporting, perform Quality of Service (QOS) handling in the user plane, perform uplink traffic verification, perform transport level packet marking, perform downlink packet buffering, forward an “end marker” to a node I access network 204 (e.g., gNB), and/or perform other types of user plane processes.

In addition, UPF 306 may perform the following functions to support MBS: interacting with SMF 304 for receiving multicast data from MB-UPF 312 for a 5GC Individual MBS traffic delivery method; and delivering multicast data to UEs 202 via a PDU session for a 5GC Individual MBS traffic delivery method.

AF 308 may provide application services to UE 202. With respect to MBS, AF 308 may perform: request multicast or broadcast service from a 5GC by providing service information including QoS requirement to the 5GC; instruct MBS session operation towards a 5GC when needed; and interact with a Network Exposure Function (NEF) for MBS related service exposure.

MB-SMF 310 may perform, for multicast and broadcast sessions: support MBS session management, including QoS control; configure MB-UPF 312 for multicast and broadcast data transport, based on the policy rules for multicast and broadcast services from a PCF or a local policy; and allocate or de-allocate Temporary Mobile Group Identities (TMGIs). For broadcast sessions, MB-SMF 310 may interact with access network 204 (via AMF 302) to control data transport using a 5GC shared MBS traffic delivery method. For multicast sessions, MB-SMF 310 may perform: interact with SMF 304 to provide SMF 304 with MBS session context information; interact with access network 204 (via AMF 302) to establish data transmission resources between MB-UPF 312 and nodes in access network 204 for a 5GC shared MBS traffic delivery method; and control MB-UPF 312 for multicast data transport using a 5GC Individual MBS traffic delivery method.

MB-UPF 312 may perform, for multicast and broadcast sessions: packet filtering of incoming downlink packets for multicast and broadcast flows; QoS enforcement and traffic usage reporting based on existing means; interact with MB-SMF 310 for receiving multicast and broadcast data; and deliver multicast and broadcast data to nodes in access network 204 for a 5GC shared MBS traffic delivery method. For multicast sessions, MB-UPF 312 may deliver multicast data to UPF 306 for a 5GC Individual MBS traffic delivery method.

MBSTF 314 may perform: provide an anchor for MBS data traffic when needed; source IP multicast; provide generic packet transport functionalities available to any IP multicast enabled application such as framing, multiple flows, packet (encoding, etc.; and provide multicast broadcast delivery of files as object flows.

MBSF 316 may perform: provide service level support for MBS sessions: interact with AF 308 and MB-SMF 310 for MBS session operations, determination of transport parameters, and session transport: select MB-SMF 310 to serve an MBS session: control MBSTF 314: and determine destination IP multicast address for the MBS session if IP multicast address is sourced by MBSTF 314.

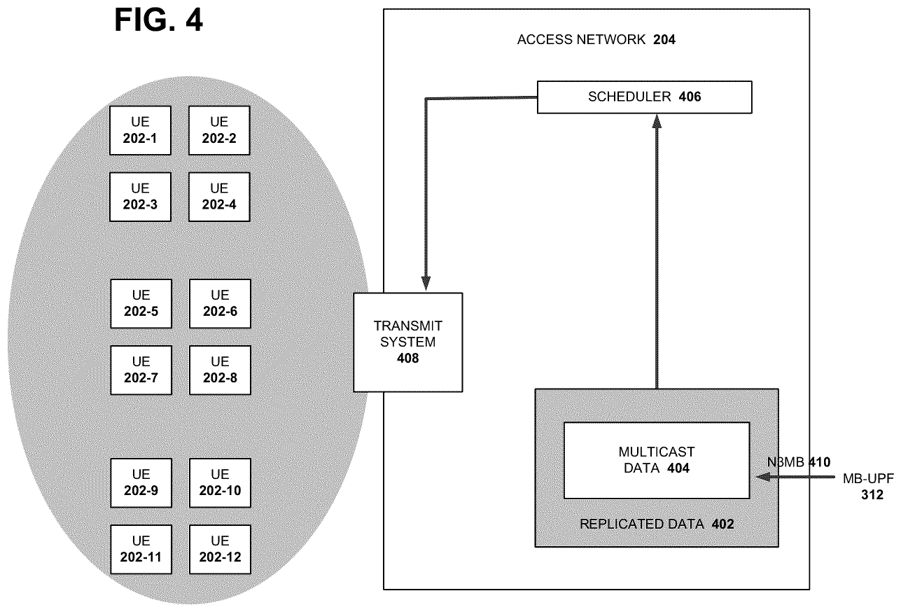

FIG. 4 illustrates an exemplary components of an MBS system, according to an implementation. As shown, the MBS system includes components that are hosted within access network 204. In the embodiment of FIG. 4, the MBS system may provide MBS without taking into account modulation schemes or MCSs of UEs 202. As shown, the MBS system includes, as part of access network 204, replicated data 402, a scheduler 406, and a transmit system 408. These components of the MBS system may be embodied in access station 210, CUs, DUs, and/or RUs of access network 204, although not illustrated for clarity.

As shown, access network 204 receives data through an N3 MB interface 410, from MB-UPF 312. A component, in access network 204, that receives the data may include, for example, a gNB, a CU-User Plane (CU-UP), or a DU. The received data is stored at one or more devices as multicast data 404 as part of data replicated 402 in access network 204. Multicast data 404 is forwarded to a scheduler 406. Scheduler 406 selects resource blocks for data downlink transmission (i.e., schedules the data) and sends the data to transmit system 408. Transmit system 408, which includes one or more antennas, then transmits the data over a shared link to UEs 202. In the example of FIG. 4, all UEs 202-1 through 202-12 receive the multicast data 402 over the shared link. Additionally, in this example, UEs 202-1 through 202-12 belong to the same multicast group and therefore have the same TMGI (e.g., assigned by MB-SMF 310).

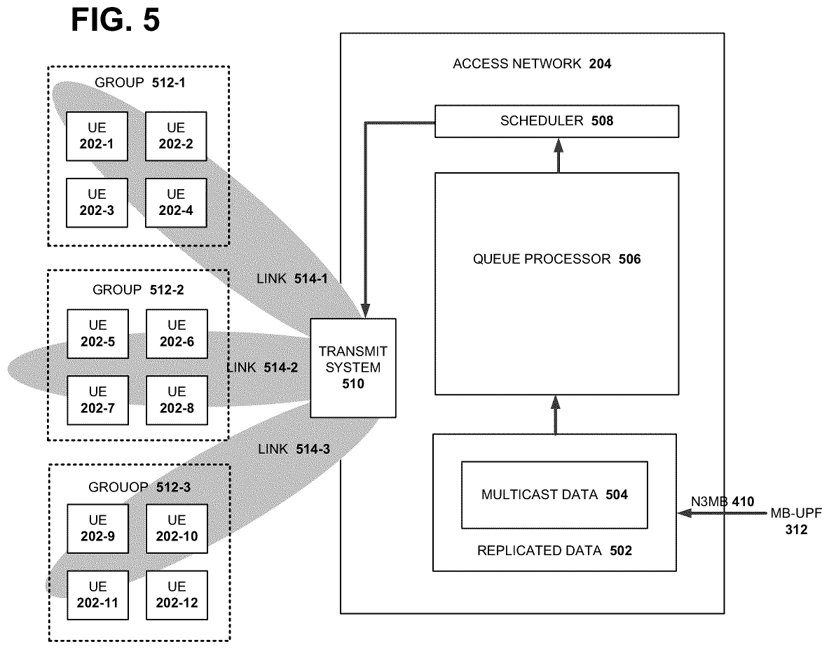

FIG. 5 shows exemplary components of an MBS system, according to another embodiment. In contrast to the MBS system of FIG. 4, the MBS system of FIG. 5 renders MBS based on modulation/MCS used at UEs 202. As shown, the MBS system includes replicated data 502, a queue processor 506, a scheduler 508, and a transmit system 510. Depending on the implementation, the MBS system may include additional, fewer, different, or a different arrangement of components than those illustrated in FIG. 5.

Replicated data 502 includes data received from UPF 306 or MB-UPF 312 at access network 204 and replicated at various components of access network 204, such as a gNB, a CU-UP or a DU. As shown, replicated data 502 includes multicast data 504 received from MB-UPF 312 over N3 MB interface 410.

Queue processor 506 may determine, for each of UEs 202 that are to participate in an MBS session, an identifier (ID) corresponding to one of particular modulation schemes or MCSs to be used at UE 202. After the determination, therefore, each ID identifies a subgroup (within the MBS group) of UEs 202 that use the same modulation scheme or MCS. Each subgroup is to receive the same data as another subgroup. In the example of FIG. 5, UEs 202-1 through 12 are placed in subgroups 512-1, 512-2, and 512-3 and assigned corresponding IDs (e.g., 1, 2, and 3). After the assignment, queue processor 506 may prepare multicast data 504 for transmission using different modulation schemes/MCSs and forward the data to scheduler 508.

Scheduler 508 may schedule the data received from queue processor 506 for transmission. Scheduler 408 assigns appropriate resource blocks (frequency-time slots) in accordance with the carrier frequencies and modulation schemes/MCSs for transmission to each of the subgroups.

Transmit system 510 may receive the scheduled data from scheduler 508 and send the scheduled data over different links. Each link may be based on a different modulation scheme/MCS (e.g., 64 QAM, 256 QAM, MCS 4. MCS 6, MCS 8, etc.) and directed to a particular MBS subgroup. For example, link 514-1 may be directed subgroup 512-1, link 514-2 may be directed to subgroup 512-2, and link 514-3 may be directed to subgroup 512-3.

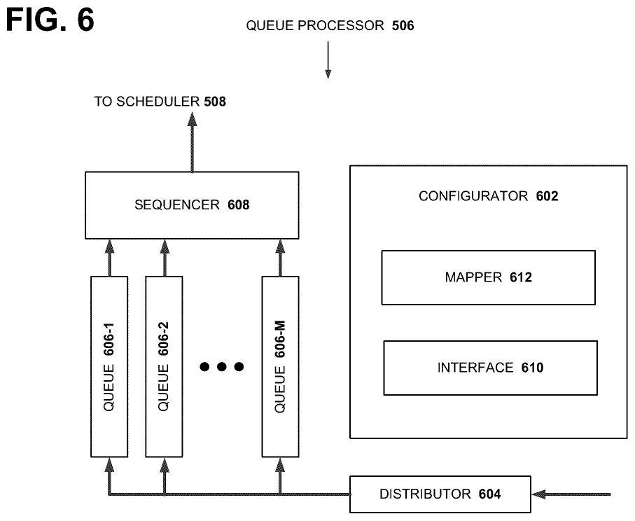

FIG. 6 shows exemplary components of queue processor 506, according to an embodiment. As shown, queue processor 506 may include a configurator 602, a distributor 604, queues 606, and sequencer 608. Depending on the implementation, queue processor 506 may include additional, fewer, different, or a different arrangement of components than those illustrated in FIG. 6.

Configurator 602 may include an interface 610 and a mapper 612. interface 610 receive device parameters for UEs 202 (e.g., UEs 202-1 through 202-12) that have joined the MBS session (e.g., UEs 202 that are assigned the same TMGI by MB-SMF 310). In addition, interface 610 may receive other operating parameter values (e.g., SINR for each UE 202), device characteristics (e.g., which UE 202 is capable of which QAM/MCS (e.g., one of 16 QAM, 64 QAM, MCS 6, MCS 8, etc.), which frequencies UE 202 may operate in, etc.).

Mapper 612 may determine, based on the information received by interface 610, a MCS index or MCS index for each of the UEs 202, where the QAM/MCS index identifies a QAM scheme/MCS. In determining QAM/MCS indices, mapper 612 may assign the same QAM/MCS index to UEs 202 that have similar device capabilities and operational characteristics. For example, assume that UEs 202-1 through 202-4 are capable of using 16 QAM, UEs 202-5 through 202-8 are capable of using 64 QAM, and UEs 202-9 through 202-12 are capable of using 256 QAM. Accordingly, mapper 612 may assign UEs 202-1 through 202-4 to MCS index 1, UEs 202-5 through 202-8 to MCS index 2 and UEs 202-9 through 202-12 to MCS index 3. Thus, after the assignment, each MCS index denotes an MB subgroup of UEs 202 that use a particular QAM scheme. In a different embodiment, each MCS index may denote an MB subgroup of UEs 202 that use a particular MCS.

After mapper 612 assigns QAM/MCS indices to UEs 202 (i.e., determines to which MB subgroup each UE 202 belongs), mapper 612 may ensure that, for each QAM/MCS index, there exists a corresponding packet queue in the MBS system. If there is no existing queue for a particular QAM/MCS index, mapper 612 may create or instantiate an appropriate queue for the QAM/MCS index and assign the queue to the QAM/MCS index. If there are extraneous queues in the system (e.g., more queues than the MCS indices exist), mapper 612 may delete or remove the extraneous queues. For example, if MCS indices 1, 2, and 3 correspond to 16 QAM, 64 QAM, and 256 QAM, mapper 612 may ensure that a 16 QAM queue, a 64 QAM queue, and a 256 QAM exist for the indices.

Distributor 604 may receive multicast data 504 and send a copy of the data to each of the queues. For example, assume that there are a 16 QAM queue, a 64 QAM queue, and a 256 QAM queue. Distributor 604 may send a copy of multicast data 504 to each of the queues.

Queues 606-1 through 606-M (herein collectively referred to as queues 606 and generically as queue 606) may receive packets from distributor 604 and hold them temporarily as they are processed by sequencer 608.

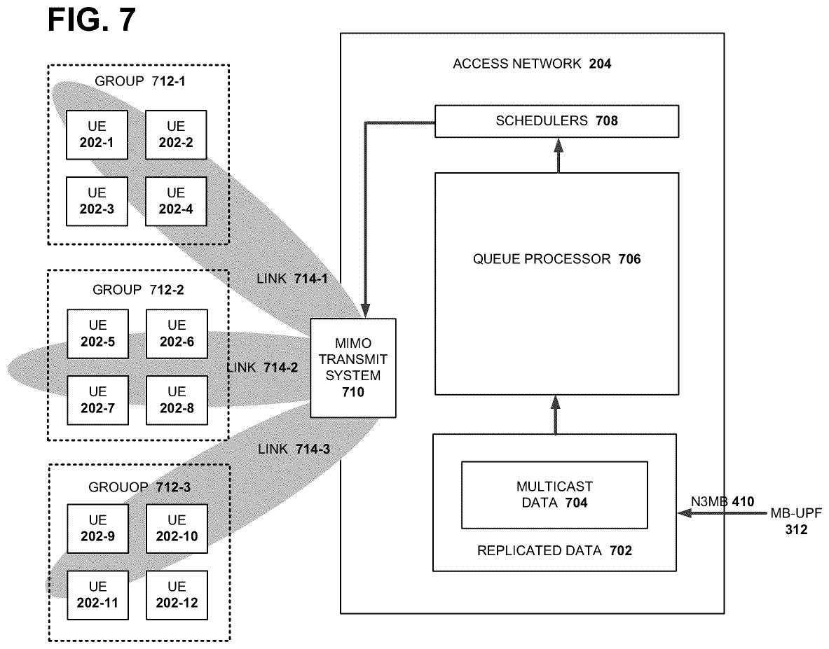

Sequencer 608 may line up or sequence the packets from queues 606 for scheduling. Since each modulation scheme/MCS results in data transmission at different rates, sequencer 608 may interleave data from each queue 606 with null data before placing them on the line. Sequencer 608 may dilute or interpolate data from different queues 606 at different rates so that data in all queues 606 are processed at a similar rate. For example, assume that queues 606-1 and 606-2 correspond to 16 QAM and 64 QAM, respectively. Since 64 QAM data would be transmitted at 4 times the rate of 16 QAM data, sequencer 608 may compensate for the faster data consumption for queue 606-1 by placing 3 null packets for each packet from queue 606-2. In a different implementation, distributor 604, rather than sequencer 608, may insert a different number of null packets into different queues 606, to compensate for different rates of queue depletion. Sequencer 608 forwards data from different queues 606 to scheduler 508. FIG. 7 shows exemplary components of an MBS system, according to yet another embodiment. In contrast to the MBS system of FIGS. 5 and 6, the MBS system of FIG. 7 renders MBS based not only on modulation schemes/MCSs of UEs 202, but also on MIMO antenna beam directions at access stations 210 and/or UE locations. As shown, the MBS system includes replicated data 702, a QAM-MIMO-Queue processor 706, schedulers 708, and a MIMO transmit system 710. Depending on the implementation, the MBS system may include additional, fewer, different, or a different arrangement of components than those illustrated in FIG. 7.

Replicated data 702 includes data received from MB-UPF 312 for multicast sessions replicated at various components of access network 204, such as a gNB, a CU-UP or a DU. As shown, replicated data 702 include multicast data 704.

QAM-MIMO-Queue processor 706 may determine, for each of UEs 202 that are to participate in an MBS session, assign a queue corresponding to particular modulation or MCS typed and a MIMO antenna beam (herein simply referred to as a beam). Each queue is to receive and hold the same data as other queues and corresponds to a particular combination of MCS index and a number that identifies a MIMO beam (e.g., a beam index). In the example of FIG. 7, UEs 202-1 through 12 are grouped into groups 712-1, 712-2, and 712-3 and assigned corresponding queues. After the queue assignment, QAM-MIMO-Queue processor 706 may prepare multicast data 704 for different combinations of modulation schemes/MCSs and beams and then forward the data to schedulers 708.

Schedulers 708 may schedule the data received from QAM-MIMO-Queue processor 704 for transmission. Scheduler 708 may assign appropriate resource blocks (frequency-time slots) in accordance with the carrier frequencies and modulation schemes/MCSs for each of the queues. In contrast to scheduler 508 which schedules all data for a transmission over a single beam, schedulers 708 may schedule data for transmission via multiple beams. In particular, schedulers 708 may schedule data for each beam separately from data for other beams, as there is a physical separation between the beams. Each of the schedulers 708 may forward a multicast stream to MIMO transmit system 710.

MIMO transmit system 710 may receive multiple streams of scheduled data from the schedulers 708 and transmit each of the streams over different beams/links. Each link may be based on modulation schemes/MCSs independent of modulation schemes/MCSs at other beams (e.g., 64 QAM, 256 QAM, MCS 4, MCS 6, etc.) and directed to a particular group of UEs 202 corresponding to the beam/queue. For example, link 814-1 may be directed to group 712-1, link 714-2 may be directed to group 712-2, and link 714-3 may be directed to group 712-3. Each link/beam may carry signals using one or more modulation schemes/MCSs.

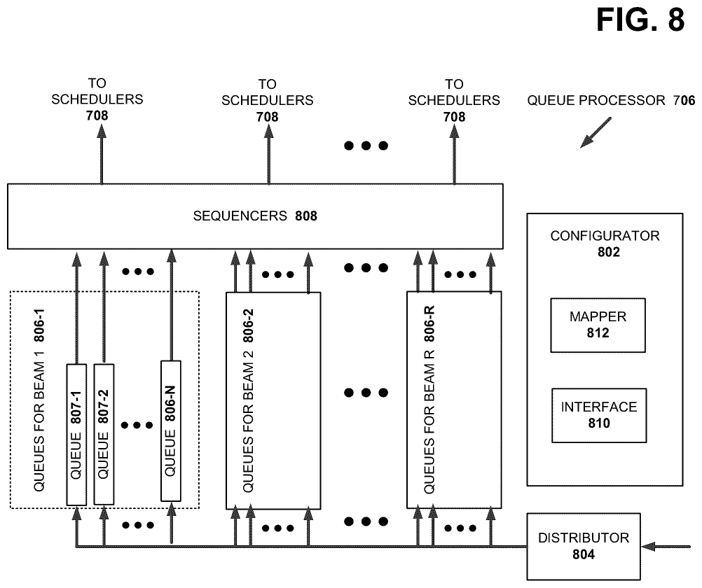

FIG. 8 shows exemplary components of QAM-MIMO-Queue processor 706, according to an embodiment. As shown, QAM-MIMO-Queue processor 706 may include a configurator 802, a distributor 804, queues 806, and sequencer 808. Depending on the implementation, QAM-MIMO-Queue processor 706 may include additional, fewer, different, or a different arrangement of components than those illustrated in FIG. 8.

Configurator 802 may include an interface 810 and a mapper 812. Interface 810 may receive device parameters of UEs 202 (e.g., UEs 202-1 through 202-12) that joined the MB session (e.g., devices that are assigned the same TMGI by MB-SMF 310). In addition, interface 810 may receive operating parameter values of the MIMO antenna in MIMO transmit system 710 and of UEs 202 (e.g., SINR for each UE 202, beam identifiers, beam location/directions, UE locations, etc.), device characteristics (e.g., which UE 202 is capable of which QAM (e.g., one of 16 QAM, 64 QAM, etc.), MIMO characteristics (e.g., number of beams that MIMO transmit system 710 supports), which frequencies UE 202 may operate in, etc.

Mapper 812 may determine, based on the information received by interface 810, two indices or IDs for each UE 202: a beam index (or beam number) and a MCS index. To determine the beam index for a UE 202, mapper 812 may determine the location of the UE 202 and identify a set of beams that will reach the UE 202, Mapper 712 may then assign to each beam, a subset of the UEs 202 based on the beam directions and the UE locations. If a UE 202 is in a location which can be reached by two or more beams from the same MIMO, the UE 202 may be assigned to the beam that optimizes a particular metric (e.g., less power needed to reach the UEs 202). Depending on the implementation, there may be an upper bound on the number of beams (e.g., due to the dimension of the MIMO).

Mapper 812 may assign, for each set of UEs 202 that have been assigned a beam number or index, a MCS index or QAM number. Given UEs 202 with the same beam index, mapper 812 may assign a MCS index for a subset of the UEs 202 with similar device capabilities and operational characteristics. For example, assume that UEs 202-1 through 202-4 have been assigned beam index of 1, and that UEs 202-1 through 202-4 are capable of using 16 QAM and UEs 202-2 and UEs 202-3 are capable of using 64 QAM. In this example, mapper 812 may assign either 16 (for 16 QAM) to UEs 202-1 through 202-4, or alternatively, assign the MCS index of 16 to UEs 202-1 and 202-4 and the MCS index of 64 to UEs 202-2 and 202-3.

After mapper 812 assigns a combination of beam index and MCS index to each of UEs 202 that share the same TMGI, mapper 812 may map, assign, or associate each of the combinations to a queue. Furthermore, mapper 812 may ensure that, for each of the combinations, there exists a corresponding queue in accordance with the association. If there is no existing queue for a particular combination of beam index and MCS index, mapper 812 may create (e.g., instantiate) an appropriate queue for the combination. If there are extraneous queues, mapper 812 may delete or remove the extraneous queues.

Distributor 804 may receive multicast data 704 for the MBS session and send a copy of the data to each of the queues. For example, assume that for beam 1, there are a 16 QAM queue, a 64 QAM queue, and a 256 QAM queue. Distributor 804 may send a copy of the multicast data to each of the queues.

Queues 806 may receive packets from distributor 804 and hold them temporarily for processing by sequencer 808. As illustrated in FIG. 8, queues 806 may be organized in accordance with beam indices. Thus, queues 806-1 through 806-N are placed in a beam 1 group. Each of queues 806-1 through 806-N may correspond to one of QAM schemes. Queues 806 for other beams (i.e., queues that belong in different groups) may be organized similarly.

Sequencers 808 may line up or sequence the packets from beam 1 group queues for transmission over beam 1, the packets from beam 2 group queues for transmission over beam 2, the packets from beam 3 group queues for transmission over beam 3, and so forth, for scheduling.

Given a particular UE group (i.e., UEs 202 that receive the same beam), since each queue for the group represents a modulation scheme/MCS and each of the modulation scheme/MCS implies data transmission at different rates, sequencer 808 may interleave data from each of the queues 806 with null data before placing them on the line for transmission over a particular beam. That is, sequencer 808 may dilute or interpolate data from different queues 806 for the beam at different rates so that data in all queues 806 for the beam are processed at a similar rate. For example, assume that queues 806-1 and 806-2 correspond to 16 QAM and 64 QAM, respectively. Since 64 QAM data would be transmitted at 4 times the rate of 16 QAM data, sequencer 808 may compensate for the faster data consumption for queue 806-2 by placing 3 null packets for each packet from queue 806-1 (16 QAM). In a different implementation, distributor 804 (rather than sequencer 808) may insert different number of null packets into different queues 806, to compensate for different rates of queue depletion.

Sequencer 808 may forward data from different queues 806 to schedulers 708. Sequencer 808 may forward all data from the queues of a given beam to the same scheduler in schedulers 708—the one responsible for scheduling packets for the corresponding beam. Scheduler 708 may schedule packets from queues of a particular beam for transmission over the corresponding beam.

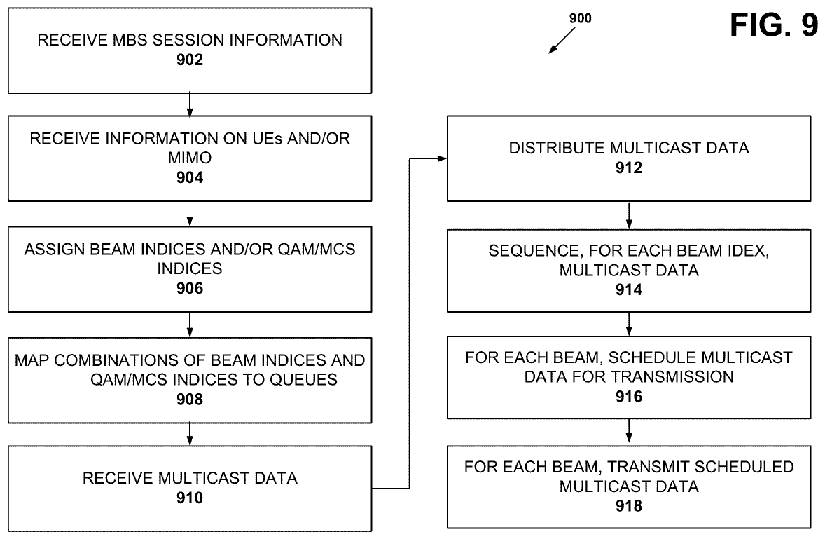

FIG. 9 is a flow diagram of an exemplary process 900 that is associated with modulation- or MCS-based MBS. Process 900 may be performed by one or more of the components illustrated in FIGS. 3-8, including the components of the MBS systems. As shown, process 900 may include receiving MBS session information and/or MBS data (e.g., multicast data) (block 902). For example, access network 204 may receive MBS session information from AMF 302 and MBS data over N3 MB interface 410 from MB-UPF 312. Process 900 may further include the MBS system receiving UE-related information (e.g., UEs 202 that have joined the JBS session) and/or MIMO information (e.g., from MIMO transmit system 710) (block 904). As described above, UE-related information may include device parameters for UEs 202 (e.g., UEs 202 that are assigned the same TMGI by MB-SMF 310). In addition, interface 810 may receive operating parameter values of the MIMO and of UEs 202 (e.g., SINR for each UE 202, beam identifiers, beam location/directions, UE locations, etc.), device characteristics (e.g., which UE 202 is capable of which QAM/MCS (e.g., one of 16 QAM, 64 QAM, MCS 4, MCS 8, etc.), MIMO characteristics (e.g., number of beams that a MIMO supports), which frequencies UE 202 may operate in, etc.

Based on the information received at block 920, the MBS system may assign beam indices and/or MCS indices to the UEs 202 (block 906), where each beam index corresponds to a particular beam of the MIMO and the QAM/MCS index corresponds to a QAM scheme/MCS (e.g., 16 QAM, MCS 8, etc.). Thereafter, the MBS system may map or assign, to each combination of beam index and QAM/MCS index, a queue (block 908).

Process 900 may further include the MBS system receiving (or continuing to receive) multicast data (block 910). Access network 204 may replicate the received data at appropriate nodes in access network 204. When the MBS system receives the MBS data or multicast data, the MBS system may distribute the multicast data to the queues of the MBS system (e.g., queues 606 or 806) (block 912) and sequence the multicast data in the queues (block 914). Multicast data from queues that have the same beam index may be sequenced separately from multicast data from the queues that have other beam indices. The MBS system may then forward each sequenced multicast data to a scheduler (e.g., one of schedulers 708). When the schedulers receive the data, each scheduler may schedule, for the corresponding beam, multicast data from queues with the corresponding beam index for transmission (block 916). Each scheduler may forward the scheduled data to a transmit system (e.g., MIMO transmit system 710). The transmit system may then transmit each scheduled multicast data over the corresponding beam to UEs 202 which have been assigned the beam and QAM/MCS indices associated with the beam or the beam index (block 918).

FIG. 10 depicts exemplary components of an exemplary network device 1000. Network device 1000 may correspond to or be included in any of the devices and/or components illustrated in FIGS. 1-8 (e.g., UE 202, access network 204, core network 206, data network 208, access station 210, the MBS systems in FIGS. 4-8, core components 302-316, etc.). In some implementations, network devices 1000 may be part of a hardware network layer on top of which other network layers and logical network components may be implemented.

As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 12. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.).

Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., a transmitter and a receiver) for network device 1010 to communicate with other devices and/or systems. For example, via network interface 1010, network device 1000 may communicate over a network, such as the Internet, an intranet, cellular, a terrestrial wireless network (e.g., a WLAN, WIFI, WIMAX, etc.), a satellite-based network, optical network, etc. Network interface 1010 may include a modem, an Ethernet interface to a LAN, and/or an interface/connection for connecting network device 1000 to other devices (e.g., a Bluetooth interface).

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of blocks have been described with FIG. 9, the order of the actions in blocks may be modified in other implementations. In addition, non-dependent acts may performed in parallel and/or in a different order.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising one or more devices configured to:
receive information pertaining to a multicast broadcast service (MBS) session;
identify, based on the information, User Equipment devices (UEs) that have joined the MBS session;
identify at least two modulation and coding schemes (MCSs) that are to be used by the UEs during the MBS session;
receive multicast data from a network component;
transmit, during the MBS session, the received multicast data to the UEs using the identified at least two MCSs.

2. The system of claim 1, wherein each of the MCSs specifies a modulation scheme that includes one of:
16 Quadrature Amplitude Modulation (16 QAM); 64 QAM; 256 QAM; or 1024 QAM.

3. The system of claim 1, wherein the network component includes a Multicast Broadcast (MB)-User Plane Function (UPF).

4. The system of claim 1, wherein the UEs have the same Temporary Mobile Group identity (TMGI).

5. The system of claim 1, wherein the one or more devices are further configured to:
replicate the multicast data on the one or more devices.

6. The system of claim 1, wherein the one or more devices are further configured to:
map each of the identified MCSs to a queue;
distribute the multicast data to the queues; and
prepare the distributed multicast data in the queues for transmission.

7. The system of claim 6, wherein when the one or more devices prepare the distributed multicast data, the one or more devices are further configured to:
sequence the multicast data to compensate for different rates, of data depletion at the queues, corresponding to the MCSs mapped to the queues.

8. The system of claim 1, wherein the one or more devices are further configured to identify at least one antenna beam that is to be used by the UEs; and
wherein when the one or more devices transmit, the one or more devices are configured to:
transmit, via a Multiple-Input Multiple-Output (MIMO) transmit system, the received multicast data to the UEs over the identified at least one antenna beam.

9. The system of claim 8, wherein the one or more devices are further configured to:
map each of the identified at least one antenna beam to a set of one or more queues;
distribute the multicast data to the queues; and
prepare the distributed multicast data in the queues for transmission.

10. A method comprising:
receiving information pertaining to a multicast broadcast service (MBS) session;
identifying, based on the information, User Equipment devices (UEs) that have joined the MBS session;
identifying at least two modulation and coding schemes (MCSs) that are to be used by the UEs during the MBS session;
receiving multicast data from a network component;
transmitting, during the MBS session, the received multicast data to the UEs using the identified at least two MCSs.

11. The method of claim 10, wherein each of the M CSs specifies a modulation scheme that includes one of:
8 Quadrature Amplitude Modulation (16 QAM); 64 QAM; 256 QAM; or 1024 QAM.

12. The method of claim 10, wherein the network component includes a Multicast Broadcast (MB)-User Plane Function (UPF).

13. The method of claim 10, wherein the UEs have the same Temporary Mobile Group identity (TMGI).

14. The method of claim 10, further comprising:
replicating the multicast data on one or more devices.

15. The method of claim 10, further comprising:
mapping each of the identified MCSs to a queue;
distributing the multicast data to the queues; and
preparing the distributed multicast data in the queues for transmission.

16. The method of claim 15, wherein preparing the distributed multicast data comprises:
sequencing the multicast data to compensate for different rates, of data depletion at the queues, corresponding to the MCSs mapped to the queues.

17. The method of claim 10, further comprising:
identifying at least one antenna beam that is to be used by the UEs, wherein transmitting the received multicast data comprises:
transmitting, via a Multiple-Input Multiple-Output (MIMO) transmit system, the received multicast data to the UEs over the identified at least one antenna beam.

18. The method of claim 17, further comprising:
mapping each of the identified at least one beam to a set of one or more queues;
distributing the multicast data to the queues; and
preparing the distributed multicast data in the queues for transmission.

19. A non-transitory computer-readable medium, comprising one or more processor-executable instructions, when executed by the one or more processors, cause the one or more processors to:
receive information pertaining to a multicast broadcast service (MBS) session;
identify, based on the information, User Equipment devices (UEs) that have joined the MBS session;
identify at least two modulation and coding schemes (MCSs) that are to be used by the UEs during the MBS session;
receive multicast data from a network component;
transmit, during the MBS session, the received multicast data to the UEs using the identified at least two MCSs.

20. The non-transitory computer-readable medium of claim 19, wherein each of the MCSs specifies a modulation scheme that includes one of:
8 Quadrature Amplitude Modulation (16 QAM); 64 QAM; 256 QAM; or 1024 QAM.
